(19) United States
(12) Patent Application Publication
(10) Pub. No.: US 2005/0002051 A1
(43) Pub. Date: Jan. 6, 2005

(54) Resource display method

(75) Inventors: Tsuneaki Kurumida, Kanagawa (JP); Tetsuo Sakai, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/677,372

(22) Filed: Oct. 3, 2003

(30) Foreign Application Priority Data
Oct. 4, 2002 (JP) 2002-292771
Oct. 4, 2002 (JP) 2002-292772

(51) Int. Cl. G06F 15/00

(52) U.S. Cl. 358/1.13; 358/1.9

(57) ABSTRACT

Types of color profiles, which are loadable into a printer, are associated and managed for every page description language (PDL) capable of being interpreted by the printer, a desired type of color profile, which is loadable into the printer, is identified based upon the types of color profiles managed, and the type of color profile identified is displayed, thereby making it possible for a user to simply determine the type of color profile that can be loaded.

### FIELD OF THE INVENTION

This invention relates to a technique for displaying types of resources that can be loaded into device having a printing function, or to a technique for at least adding on and deleting resources.

### BACKGROUND OF THE INVENTION

Conventionally, a downloader that loads resources such as fonts, forms and color profiles of a printer into the printer is for the purpose of loading the same resources into a plurality of devices. A resource that has been registered with the downloader is loaded into each device.

In a case where the color profile of a printer is loaded into the printer, use is made of a PostScript—dedicated downloader such as Color Wise Profile Manager for Canon printers. This downloader is such that color-matching processing executed in a PostScript printer is capable of being applied to a source profile, destination profile and simulation profile and therefore is so adapted that all of these color profiles can be loaded.

With the above-described downloader according to the prior art, however, PDLs (Page Description Languages) that can be loaded are limited and it has not been possible to deal with a case where color matching processing by the printer differs depending upon the PDL. For example, with PostScript cited above, it Is possible to execute precise color matching processing by loading both the source and destination profiles. However, if the destination profile is loaded into a printer in which only the source profile can be loaded, errors and other problems arise.

Further, in NetSpot Resource Downloader downloading fonts and macro from a host PC (personal computer) to Canon printers, the prior art is such that in a case where a resource that has not been registered with the downloader has been registered with a device (printer), the resource within the device will be deleted.

Furthermore, in a case where multiple users employ a downloader from their own individual personal computers to download a resource to a common device (printer), a resource that has been downloaded by another user's PC will be deleted because it will not have been registered in the resource list that has been downloaded by a user's PC.

According to the prior art, however, the following problems arise:

(1) Assume that a resource capable of being used by all printer users, such as a font or form, irrespective of the state of the personal computer has already been stored within a printer at download time. If this resource is unnecessary, garbling of characters and loss of layout will be caused unless the resource is deleted.

(2) On the other hand, a resource such as a color profile that carries out matching with a personal computer is such that the necessary resource differs from user to user. In addition, though a resource that has already been stored in a printer will not have an influence upon individual users., other users will no longer be able to use the printer normally if the resource is deleted.

Thus, a problem with the prior art is that it is difficult to handle, at one time, two or more different types of resources that do and do not require deletion.

### SUMMARY OF THE INVENTION

Accordingly, an object of the present invention is to display the type of resource, which is capable of being loaded into a load-destination device, based upon information of the load-destination device that loads the resource.

Another object of the present invention is to change over processing of a resource, which is capable of being loaded into a device, in accordance with the resource to be loaded into the device.

According to the present invention, the foregoing objects are attained by providing a resource display method for displaying types of resources capable of being loaded into a device having a printing function, comprising the steps of: associating and managing types of resources, which are loadable into a device, for every item of information that distinguishes types of print data capable of being interpreted by the device; identifying a desired type of resource, which is loadable into the device, based upon the types of resources managed; and displaying the type of resource identified.

Further, in accordance with the present invention, there is provided an information processing apparatus for displaying types of resources capable of being loaded into a device having a printing function, comprising: management means for associating and managing types of resources, which are loadable into a device, for every item of information that distinguishes types of print data capable of being interpreted by the device; identification means for identifying a desired type of resource, which is loadable into the device, based upon the types of resources manag d; and display control means for exercising control so as to display the type of resource identified on display means.

Further, in accordance with the present invention, there is provided a resource processing method for at least adding on and deleting resources capable of being downloaded to a device having a printing function, comprising: a decision step of deciding processing of a resource, which is downloadable to a device, in dependence upon the resource to be downloaded to the device; and a changeover step of changing over processing of the resource based upon the result of the decision made at the decision step.

Further, in accordance with the present invention, there is provided a resource processing apparatus for at least adding on and deleting resources capable of being downloaded to a device having a printing function, comprising: decision means for deciding processing of a resource, which is downloadable to a device, in dependence upon the resource to be downloaded to the device; and changeover means for changing over processing of the resource based upon the result of the decision made by the decision means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating the configuration of a printing system according to an embodiment of the present invention;

FIG. 2 is a diagram illustrating one screen of a resource downloader according to this embodiment;

FIG. 3 is a diagram illustrating one screen of a resource downloader according to this embodiment;

FIG. 4 is a flowchart representing the operation of the resource downloader;

FIG. 5 is a screen concerning processing (step S401), which is shown in FIG. 4, for creating a device group;

FIG. 6 is a screen concerning processing (step S402), which is shown in FIG. 4, for creating a device group;

FIG. 7 is a diagram illustrating the structure of a device information file according to this embodiment;

FIG. 8 is a flowchart illustrating a procedure for deciding types of resources displayed at the time of display-group creation;

FIG. 9A is a diagram illustrating a resource management table and FIG. 9B a diagram illustrating a mapping table;

FIG. 10 is a diagram illustrating the screen of a resource downloader when a color profile is loaded into a LIPS printer;

FIG. 11 is a diagram illustrating the screen of a resource downloader when a color profile is loaded into a PS printer;

FIG. 12 is a screen illustrating the details of a color profile file;

FIG. 13 is a flowchart of processing for discriminating whether a color profile can or cannot be loaded;

FIG. 14 is a screen illustrating the details of a font file;

FIGS. 15A and 15B are diagrams illustrating conversion tables between printer character codes and internal codes of font data;

FIG. 16 is a diagram representing an operation for setting the details of a font; and

FIG. 17 is a flowchart illustrating an operation for loading a font.

### DESCRIPTION OF THE PREFERRED EMBODIMENT

A preferred embodiment of the present invention will now be described in detail with reference to the drawings.

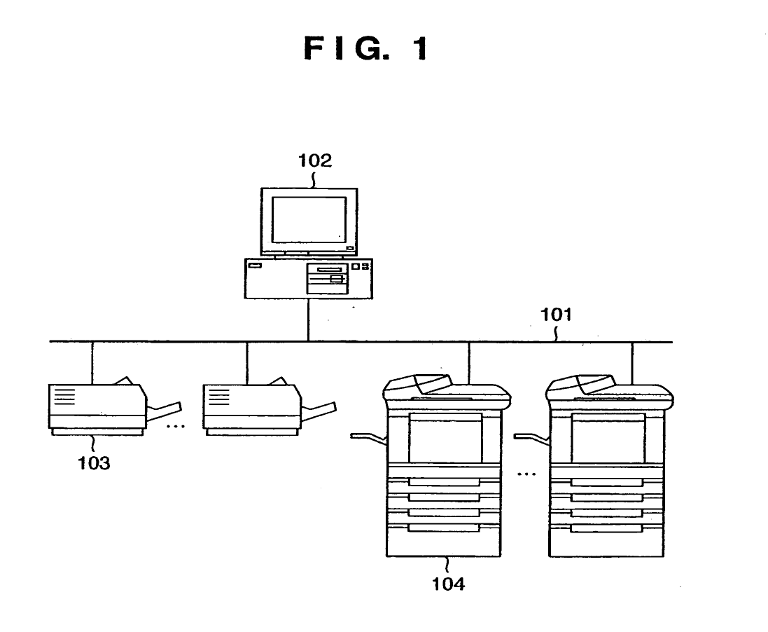

FIG. 1 is a diagram that best illustrates the features of a printing system in which a downloader according to this embodiment is used. The configuration of the printing system according to this embodiment will be described with reference to FIG. 1.

In FIG. 1, a network 101 such as a local-area network (LAN) interconnects a user personal computer 102 and printers 103, 104 etc. The user personal computer 102 is employed when the user specifies load processing for loading a resource of a printer (described later) into a printer. The printer 103, which is capable of monochrome printing, has an internal storage device such as a hard disk or flash memory. Fonts and forms utilized at the time of printing are loaded into the printer from the user personal computer 102.

The printer 104, which is capable of printing in color, has an internal storage device such as a hard disk or flash memory. Not only fonts and forms utilized at the time of printing but also a color profile (Conformance to ICC) equivalent to a color matching table utilized in color matching at the time of printing are loaded into the user personal comput r 102.

In the example illustrated in FIG. 1, the one user personal computer 102 is capable of loading resources into the printers connected to the network 101, though a plurality of personal computers may be connected and resources may be loaded from each personal computer. Further, resources may be loaded into a printer connected to another network via a router or gateway.

Described next will be a resource downloader for loading a resource such as a font, form (macro) or color profile from the user personal computer 102 to the printer 103 (104) in response to a command from the user.

It should be noted that a software module for sending data or the like from a computer to a device such as a printer is referred to as a “downloader”. Moreover, the resource downloader has been installed in the user personal computer 102.

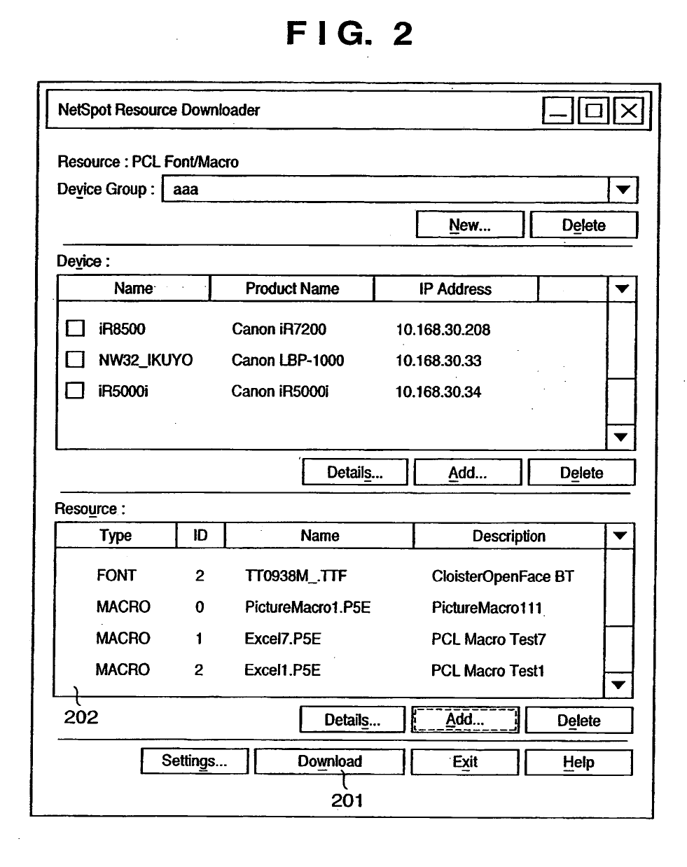

FIG. 2 is a diagram illustrating the screen of a resource downloader according to this embodiment. This screen is a user interface screen for a case where fonts and forms (macro) are loaded into a printer. In response to a download button 201 being clicked by the user, addition and deletion of fonts and forms are carried out in order to set fonts and forms internally of the printer in the manner specified on a screen 202 shown in FIG. 2. More specifically, if fonts or forms not specified on the screen 202 are inside the printer, these are deleted; if fonts or forms specified on the screen 202 are inside the printer, these are left as is; if fonts or forms specified on the screen 202 are not inside the printer, then these are loaded into the printer. It should be noted that a form is executed as a macro command of a print command. In this embodiment, macros and forms are treated as synonyms.

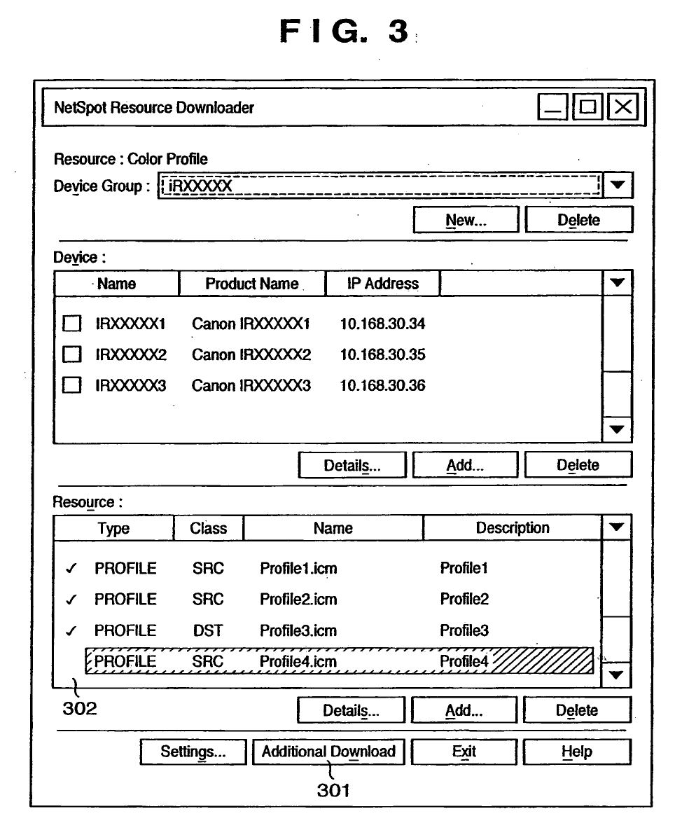

FIG. 3 is a diagram illustrating the screen of a resource downloader according to this embodiment. This is a user interface screen for a case where a color profile is loaded into the printer. In response to a download button 301 being clicked by the user, color profile data being specified on a screen 301 shown in FIG. 3 is added on. More specifically, if the color profile data is inside the printer, it is left as is regardless of the indication on the screen 302; if the color profile data indicated on the screen 302 is not inside the printer, it is loaded into the printer. It should be noted that although a color profile is displayed as a “Profile” or “PROFILE”. etc., on the screen, these are identical in meaning.

A difference in processing between FIGS. 2 and 3 gives rise to a difference in the way printer sources are used. Specifically, if a font or form differs from printer to printer in a network environment in which print data is sent from various personal computers to various printers, there are cases where this will lead to garbling of characters, data error and print malfunction if the data is superfluous data. On the other hand, color profile data is data that is necessary in order to perform color matching. If color profile data of a display (monitor) being used by any personal computer is not inside a printer, color matching cannot be performed but the fact that the data is superfluous does not matter. That is, as seen from any user, it will suffice if color profile data for this user is present within the printer used by this user; whatever else is inside this printer does not matter to the user. However, fonts and forms must be the same in all printers used by all users who share at least the same document.

Processing by the resource downloader for loading the above-mentioned printer resources to a printer will be described next.

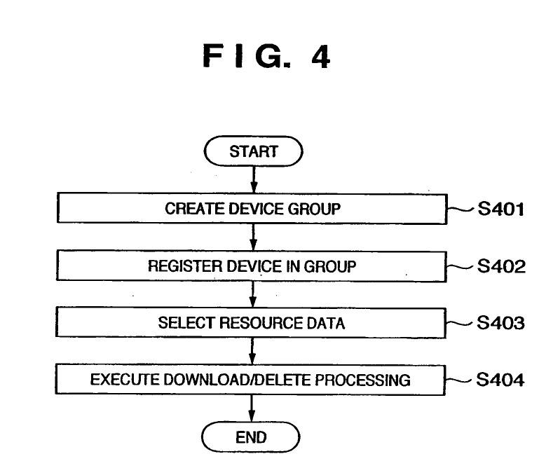

FIG. 4 is a flowchart illustrating the operation of the resource downloader. A device group is created at step S401 in FIG. 4. The device group is a grouping of a plurality of printers or multifunction peripherals and serves as a single unit when loading resources. Further, a plurality of device groups can be created with respect to each type of printer resource. That is, devices that load the same fonts and forms at one time are collected together as one group. If there are devices that similarly load other fonts and forms, then these devices are collected into another group. The same is true for color profile data.

Next, at step S402, a device is registered in the device group. This downloader program assumes that each device has been connected via TCP/IP. Registration of a device usually is performed by specifying an IP address. It is possible to make a selection from a device list, if the program is able to display the device list, though the gist of the present invention is unchanged by the type of operation. Further, the type of connection, e.g., connection via a network or a non-network connection such as by a USB or RS-232C, has no bearing upon the gist of the present invention.

It should be noted that there are cases where printers that can be registered are limited depending upon the type of resource. In other words, in a case. where a color profile has been selected as the type of resource, a monochrome printer cannot be registered.

Next, at step S403, resource data to be loaded into a device group is selected. The type of selectable resource is a resource that was specified when the device group was created, and a case in which a further limitation is imposed depending upon the type of printer is conceivable. For example, even if a printer is one in which color profile data can be loaded, there are also printers in which only data whose color space is RGB can be loaded and printers in which both RGB and CMYK data can be loaded.

When the selection of the resource data is completed, which resource is to be loaded into which printer is set. Then, at step S404, resource load processing is executed in accordance with a command from the user, and load/delete processing is executed. If types of selected resources are fonts and forms, a screen of the kind shown in FIG. 2 for adding/deleting resources is displayed. Clicking the download button 201 causes processing for both addition and deletion of resources to be executed. Further, if the resource type is a color profile, a screen of the kind shown in FIG. 3 which is solely for adding on resources is displayed. Clicking the download button 301 causes the resources to be added on.

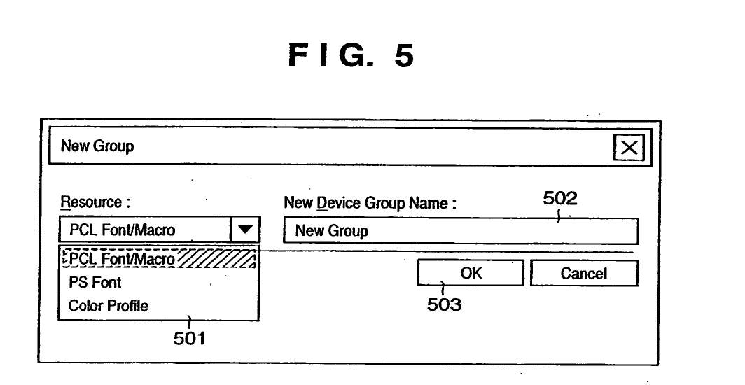

FIG. 5 shows a screen associated with the processing (step S401 in FIG. 4) for creating a device group. A screen 501 in FIG. 5 displays types of resources in accordance with a table of resource types, described later. An area 502 is for entering the name of the device group. The device group is created by selecting the type of resource from the display screen 501, entering the name of the group in the area 502 and then clicking an “OK” button.

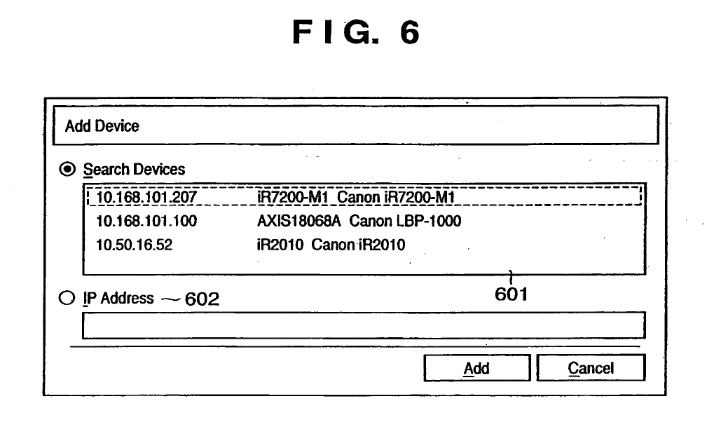

FIG. 6 shows a screen associated with the processing (step S402 in FIG. 4) for registering a device group. A list display screen 601 in FIG. 6 is for displaying a list of devices that are on the same subnet. One or more printers of interest are selected from this list. Printers listed up are capable of having resources, which were specified when the device group was created, loaded therein. In this embodiment, registration is possible by entering an IP address 602.

Described next will be a device information file created by gathering device information from each device when the system is started up or when the device configuration of the system has changed, as in a case where a device has been connected anew.

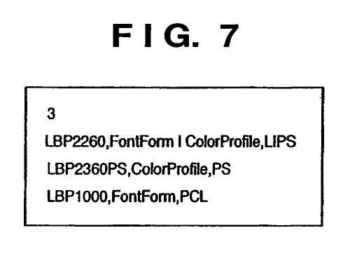

FIG. 7 is a diagram illustrating the structure of a device information file according to this embodiment. The device information file shown in FIG. 7 manages correspondence among the names of devices, loadable resources and PDLs (Page Description Languages) used by printers.

In the example shown in FIG. 7, the number of managed devices is “3”; “FontForm” and “ColorProfile” have been registered as resources loadable into a printer whose device name is “LBP2260”, and the PDL registered is “LIPS”; “ColorProfile” has been registered as a resource loadable into a printer whose device name is “LBP2360PS”, and the PDL registered is “PS”; and “FontForm” has been registered as a resource loadable into a printer whose device name is “LBP1000”, and the PDL registered is “PCL”.

A method of creating a resource-type table that contains types of resources displayed on the display screen 501 of FIG. 5 when the device-group creation processing (step S401) is executed will-be described based upon the device information file set forth above.

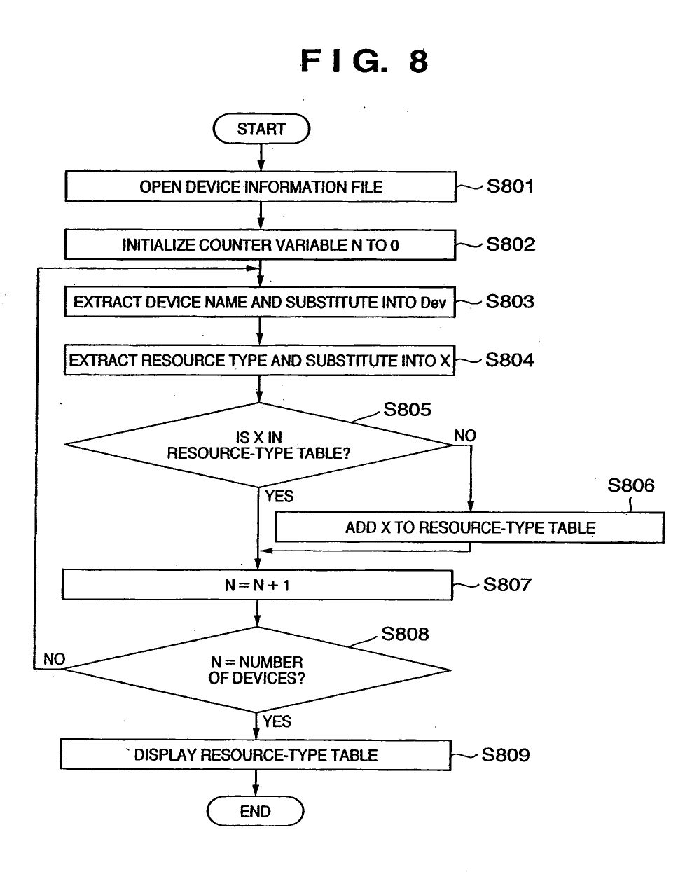

FIG. 8 is a flowchart illustrating processing for deciding types of resources displayed when a device group is created. First, at step S801 in FIG. 8, the above-mentioned device information file is opened, then, at step S802, a counter variable N is initialized to zero. Next, at step S803, a device name is extracted from the device information file based upon the counter variable N and is substituted into a device-name parameter Dev. A type of resource that can be loaded into a device whose device name is the parameter Dev is substituted into a parameter X at step S804. Substitution into the parameter X is possible even if there are a plurality of resource types.

Next, at step S805, it is determined whether the type of resource that has been substituted into the parameter X is present in a resource-type table. If the type of resource is not in the resource-type table. control proceeds to step S806, at which the type of resource that has been substituted into the parameter X is added to the resource-type table. If a plurality of resource types have been substituted into the parameter X, then the processing of steps S805 and S806 is repeated with respect to each of the resource types.

If processing for addition to the resource-type table at step S806 has ended, or if it has been found at step S805 that the resource type is already in the resource-type table, then control proceeds to step S807 to increment the counter variable N. Then, at step S808, it is determined whether the counter variable N is equal to the number of types. If processing has not been applied to the number of types, control returns to step S803 and the above-described processing is repeated. If processing has been applied to all types, then control proceeds to step S809, where the types of resources that have been stored in the resource-type table are displayed. This display is the display screen 501 shown in FIG. 5. That is, resource types that are not the object of display are not the object of loading.

Described next will be an operation for displaying types of color profiles, which can be loaded into a printer for every PDL, on a user interface screen when a user loads a color profile by the downloader by identifying the PDL of the printer.

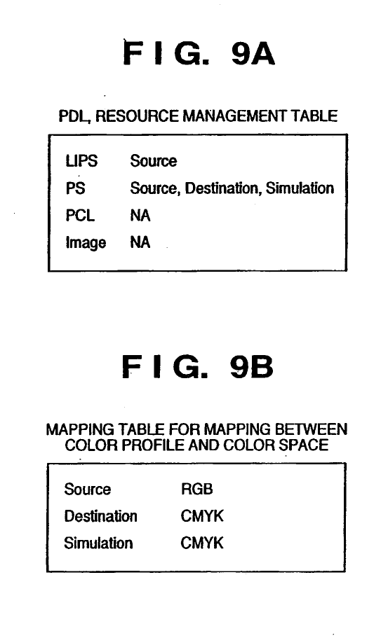

FIGS. 9A and 9B are diagrams illustrating a resource management table and a mapping table, respectively. FIG. 9A shows a PDL and resource management table. This is a table in which color profiles are classified according to application and are associated with PDLS. Types of loadable color profiles have been decided for each PDL, as illustrated. Specifically, in the case of LIPS, a source color profile is capable of being used. In the case of PS, a source color profile, a destination color profile and a simulation profile are usable. Color profiles cannot be loaded with regard to a printer whose PDL is PCL or Image.

FIG. 9B shows a mapping table of mapping between color profiles and color spaces. The color space of a color profile capable of serving as a source is expressed by RGB, as illustrated. Similarly, destination and simulation color profiles have their color spaces expressed by CMYK. A source usually is a CRT monitor or liquid crystal monitor and uses RGB. A destination or simulation is a printing device such as a printer, and CMYK is used as in ink or toner.

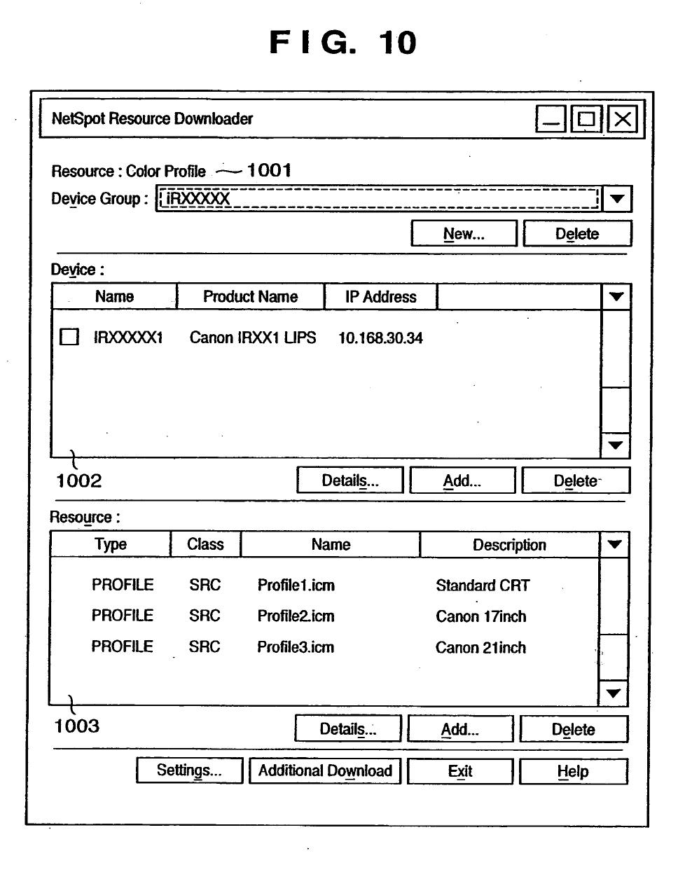

FIG. 10 is a diagram illustrating the screen of a resource downloader when a color profile is loaded into a LIPS printer. As shown in FIG. 10, a color profile has been set at 1001 as the type of resource. Further, a LIPS printer has been registered on a screen shown at 1002. In this case, as should be apparent from FIG. 10, the resource can be loaded as a source color profile only where the color space is a color profile of RGB. Only sources (SRC) are registered as types (classes) of loadable color profiles on a screen indicated at 1003.

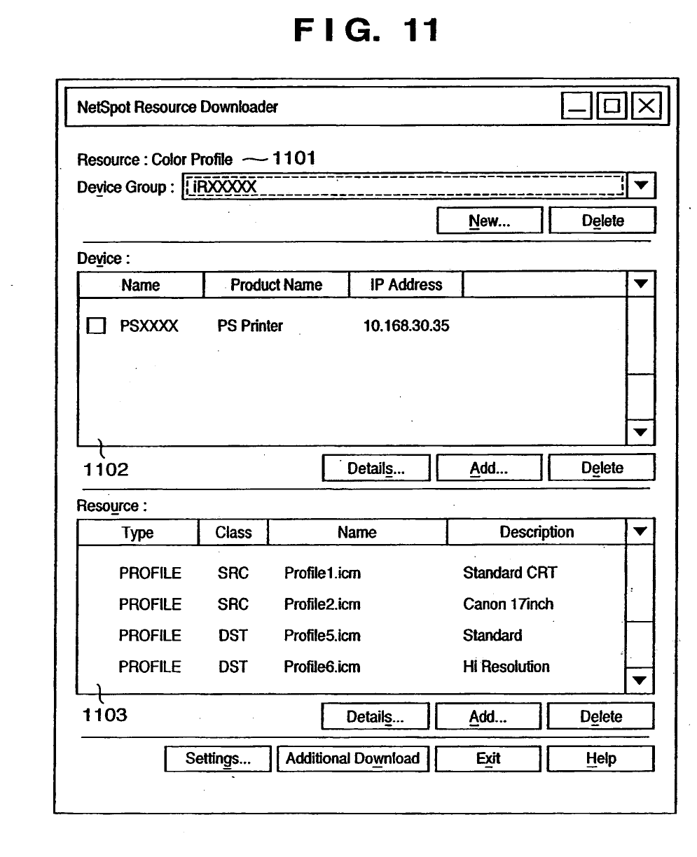

FIG. 11 is a diagram illustrating the screen of a resource downloader when a color profile is loaded into a PS printer. As shown in FIG. 11, a color profile has been set at 1101 as the type of resource. Further, a PS printer has been registered on a screen shown at 1102. In this case, as should be apparent from FIG. 11, the resource is a color profile and a color profile whose color space is RGB can be loaded as a source color profile. Furthermore, a color profile whose color space is CMYK can be loaded as a destination color profile. Two types, namely source (SRC) and destination (DST), are registered as types (classes) of loadable color profiles on a screen indicated at 1103.

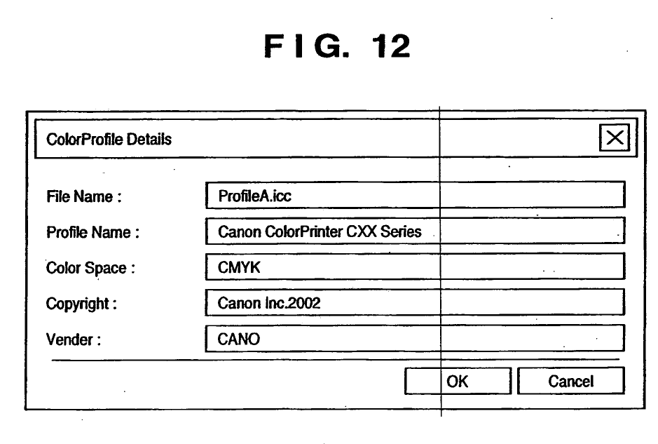

FIG. 12 is a screen illustrating the details of a color profile file. As shown in FIG. 12, file name, profile name, color space, copyright and vender are displayed in a color profile. It should be noted that these items of information, with the exception of the file name, are retained in the color profile data and are used to discriminate the type of color profile data.

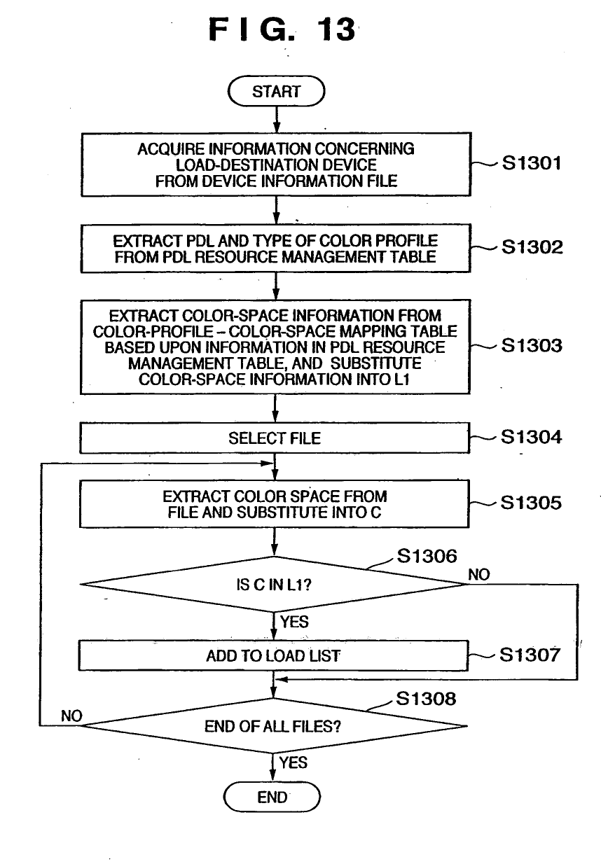

FIG. 13 is a flowchart of processing for discriminating whether a color profile can or cannot be loaded. First, at step S1301 in FIG. 13, information concerning a load-destination device is extracted from the device information file at step S1301, then a PDL and type of color profile of this PDL are extracted from the PDL resource management table of FIG. 9A at step S1302. Next, at step S1303, color-space information (one or a plurality of items thereof) is extracted from the mapping table of color profiles and color spaces of FIG. 9B based upon the type of color profile that has been extracted at step S1302, and this information is stored in a variable L1. A file to be loaded is then selected at step S1304. One or more files may be selected.

Next, at step S1305, color-space information is extracted from one selected file to be downloaded and this information is substituted into a variable C. It is determined at step S1306 whether the color-space information that has been stored in the variable C is included in the variable L1. If the information is included in the variable L1, control proceeds to step S1307, at which it is judged that loading is possible and an addition is made to the load list. If the information is not included in the variable L1, control proceeds to step S1308, at which it is determined whether processing has been applied to all files. If processing of all files has not been completed, control returns to step S1305 and the above-described processing is repeated. If processing of all files has been completed, processing of FIG. 13 is exited.

Described next will be operation performed when a font is loaded into a printer, namely an operation for loading font data as is if the font is that of a usual character code, and for adding on a character-code conversion table and loading font data if the font is that of a special character code such as an external (non-standard) character.

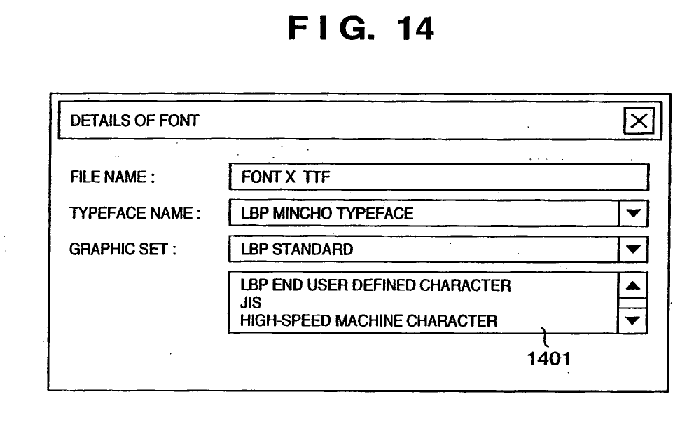

FIG. 14 shows a screen illustrating the details of a font file. As illustrated in FIG. 14, it is possible to display a file name, set a typeface name by a user and set a graphic set (a mapping of character codes and character patterns; ASCII, Latin1, JISX0208, etc.). The graphic set is information for defining line of characters. For example, even if the character code is the same, character that differs is displayed, in accordance with whether a hiragana is selected or katakana is selected as the graphic set. That is, the graphic set is information for designating under what kind of system the character code is.

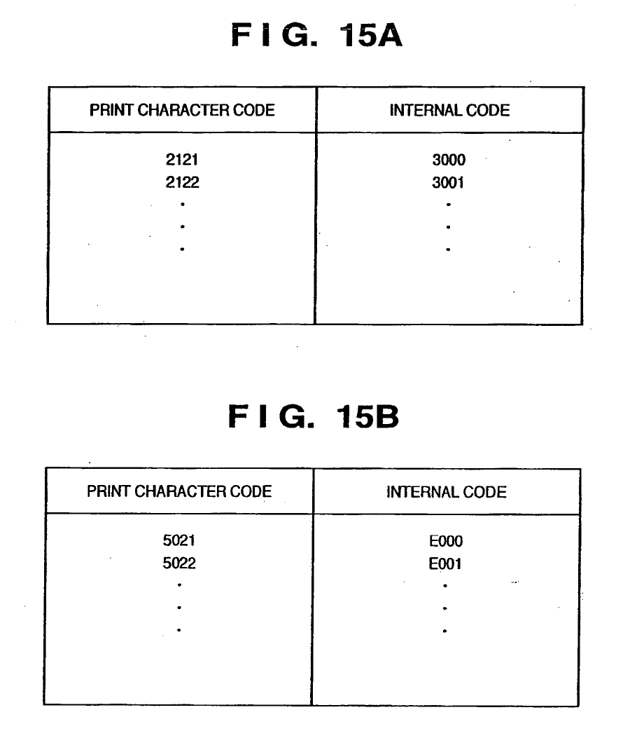

FIGS. 15A and 15B are diagrams illustrating conversion tables between printer character codes and internal codes of font data. FIG. 15A illustrates an example of a standard mapping, this mapping being retained internally of the printer. FIG. 15B illustrates an example of a mapping of external characters. This mapping is not retained internally of the printer. The printer codes of FIGS. 15A and 15B are in line with hexadecimal notation according to JIS. Each code is composed of two bytes and takes on a range of 0x21 to 0x7E (where 0x represents a hexadecimal number) for both the higher- and lower-order bytes. An internal code of font data is Unicode and is represented by USC2 (two bytes per character). These printer character codes and internal codes are possessed in a quantity equivalent to all characters printed. In the case of the standard mapping, there are 8836 characters. Though the mapping of external characters differs depending upon the font, the maximum number of characters is 1880 (the End User Defined character area of shift JIS).

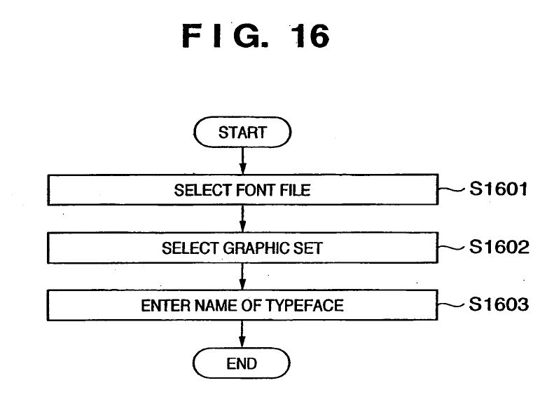

FIG. 16 is a diagram representing an operation for setting the details of a font. First, at step S1601 in FIG. 16, a font file for performing a detailed setting is selected and specified from the font file being displayed on the screen. Here the details screen shown in FIG. 14 is displayed. Next, at step S1602, a graphic set selected and specified is chosen from the list 1401. The name of the typeface is entered at step S1603 and processing is then exited.

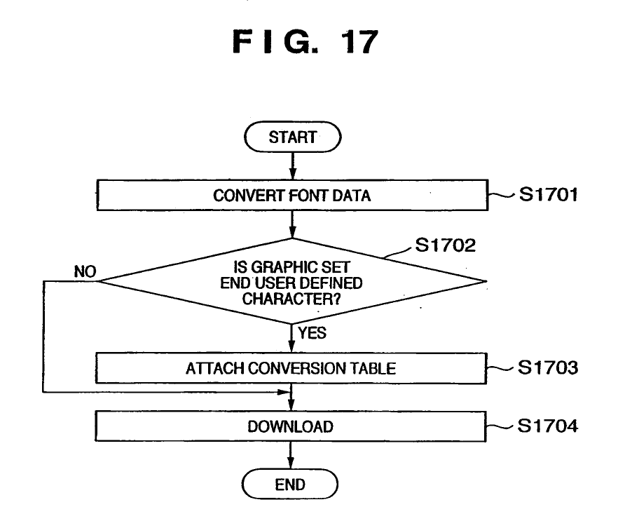

FIG. 17 is a flowchart illustrating an operation for loading a font. First, at step S1701 in FIG. 17, a font is converted to a loadable format (a format that depends upon the type of printer). Next, at step S1702, it is determined whether the graphic set selected at step S1602 above is that of an end user defined character. In the case of an end user defined character, control proceeds to step S1703, at which a conversion table for external mapping is attached to the font obtained by the conversion at step S1701. If it is found at step S1702 that the character is not an end user defined character, control proceeds to step S1704, where the font obtained by the conversion at step S1701 is loaded.

Thus, as described above, if the color space of a color profile is RGB, it is judged that the profile is a source profile; if the color space is CMYK, then it is judged that the profile is a destination profile or a simulation profile. On the other hand, by identifying whether a source profile is loadable, whether a destination profile is loadable or whether a simulation profile is loadable based upon the PDL of a device into which a profile is to be loaded, it is possible to determine whether a color profile is loadable or not.

Further, by changing over processing at the time of download in dependence upon the type of resource, it is possible to deal with fonts, forms and color profiles by the optimum processing method automatically by the same downloader. Further, even if a resource is one for which different processing is sought at the time of download, it is possible to implement the optimum processing method by the same operation in dependence upon the type of this resource.

The present invention can be applied to a system constituted by a plurality of devices (e.g., a host computer, interface, reader, printer, etc.) or to an apparatus comprising a single device (e.g., a copier or facsimile machine, etc.).

Furthermore, it goes without saying that the object of the invention is attained also by supplying a recording medium storing the program codes of the software for performing the functions of the foregoing embodiment to a system or an apparatus, reading the program codes with a computer (e.g., a CPU or MPU) of the system or apparatus from the recording medium, and then executing the program codes.

In this case, the program codes read from the recording medium implement the novel functions of the embodiment and the recording medium storing the program codes constitutes the invention.

Examples of storage media that can be used for supplying the program code are a floppy (registered trademark) disk, hard disk, optical disk, magneto-optical disk, CD-ROM, CD-R, magnetic tape, non-volatile memory card or ROM, etc.

Furthermore, besides the case where the aforesaid functions according to the embodiment are implemented by executing the program codes read by a computer, it goes without saying that the present invention covers a case where an operating system or the like running on the computer performs a part of or the entire process in accordance with the designation of program codes and implements the functions according to the embodiment.

It goes without saying that the present invention further covers a case where, after the program codes read from the storage medium are written in a function expansion board inserted into the computer or in a memory provided in a function expansion unit connected to the computer, a CPU or the like contained in the function expansion board or function expansion unit performs a part of or the entire process in accordance with the designation of program codes and implements the function of the above embodiment.

In accordance with the embodiment, a user is capable of simply determining the type of loadable r source by displaying types of resources that are loadable into a load-destination device based upon infoxmation concerning the load-destination device into which the resource is to be loaded.

In accordance with the embodiment, optimum processing conforming to a resource can be executed by changing over the processing of a resource, which is downloadable to a device, in accordance with the resource to be downloaded to the device.

As many apparently widely different embodiments of the present invention can be made without departing from the spirit and scope thereof, it is to be understood that the invention is not limited to the specific embodiments thereof except as defined in the appended claims.

1. A resource display method for displaying types of resources capable of being loaded into a device having a printing function, comprising the steps of:
associating and managing types of resources, which are loadable into a device, for every item of information that distinguishes types of print data capable of being interpreted by the device;
identifying a desired type of resource, which is loadable into the device, based upon the types of resources managed; and
displaying the type of resource identified.

2. The method according to claim 1, wherein the information that distinguishes a type of print data capable of being interpreted by the device is a page description language.

3. The method according to claim 2, wherein the type of resource is a type of color profile that has been associated with the page description language.

4. The method according to claim 3, wherein the type of color profile is displayed in a list as the type of resource.

5. The method according to claim 4, wherein the type of color profile depends upon color space.

6. An information processing apparatus for displaying types of resources capable of being loaded into a device having a printing function, comprising:
management means for associating and managing types of resources, which are loadable into a device, for every item of information that distinguishes types of print data capable of being interpreted by the device;
identification means for identifying a desired type of resource, which is loadable into the device, based upon the types of resources managed; and
display control means for exercising control so as to display the type of resource identified on display means.

7. A resource processing method for at least adding on and deleting resources capable of being downloaded to a device having a printing function, comprising:
a decision step of deciding processing of a resource, which is downloadable to a device, in dependence upon the resource to be downloaded to the device; and
a changeover step of changing over processing of the resource based upon the result of the decision made at said decision step.

8. The method according to claim 7, wherein the resource is at least a font or a form or a color profile.

9. The method according to claim 8, wherein if the resource is a font or form, the processing of this resource is changed over at the changeover step to processing for adding and deleting resources.

10. The method according to claim 8, wherein if the resource is a color profile, the processing of this resource is changed over at the changeover step to processing for adding on resources.

11. The method according to claim 7, wherein changeover the processing of resources is performed by changing over an interface screen provided to a user.

12. A resource processing apparatus for at least adding on and deleting resources capable of being downloaded to a device having a printing function, comprising:
decision means for deciding processing of a resource, which is downloadable to a device, in dependence upon the resource to be downloaded to the device; and
changeover means for changing over processing of the resource based upon the result of the decision made by said decision means.

13. A program for causing a computer to implement the resource display method set forth in claim 1.

14. A program for causing a computer to implement the resource processing method set forth in claim 7.

15. A computer-readable recording medium on which the program set forth in claim 13 has been recorded.

16. A computer-readable recording medium on which the program set forth in claim 14 has been recorded.
